(19) United States
(12) Patent Application Publication
(10) Pub. No.: US 2011/0314063 A1
(43) Pub. Date: Dec. 22, 2011

(54) Method and apparatus for an electronic environment for legal services having a dynamic workspace to prepare and exhibit the same

(75) Inventors: Armando Ramirez, Dixon, CA (US); Ryan Lauchli, Pasadena, CA (US)

(73) Assignee: Bondvention, San Francisco, CA (US)

(21) Appl. No.: 13/134,740

(22) Filed: Jun. 16, 2011

Related U.S. Application Data
(60) Provisional application No. 61/398,097, filed on Jun. 21, 2010.

(51) Int. Cl. G06F 17/30

(52) U.S. Cl. 707/802; 707/E17.005

(57) ABSTRACT

The present invention is capable of electronically linking four types of users; inventors, intellectual property professionals, investors, and the general public. This virtual environment through its application software is capable of semi-automatically creating provisional patent applications. The application preparation system guides the user through the preparation of a provisional patent application, and it prepares the necessary forms automatically, including the electronic submission of this information to the respective regulatory entity, in the present embodiment, the United States Patent and Trademark Office (USPTO). The generation of inventions/ideas are collected, stored, and displayed in real-time, and they are exhibited in a specific section. Patent attorneys and patent agents can be contacted for their services through the network, and they have access to the application preparation system, provided the inventor approves them. The network also supports invention and user critiques and/or reviews, and the submission of information, for example prior art documents. Each invention file created supports the submission of drawings and videos.

### CROSS-REFERENCE TO RELATED APPLICATION

This application claims priority, under 35 U.S.C. §119(e), from U.S. Provisional Patent Application Ser. No. 61/398,097 “Method of Data Processing System, Management, and Business Practice” by Armando P. Ramirez, filed Jun. 21, 2010, the entirety of which is herein incorporated by reference.

### BACKGROUND

A. Technical Field

The present invention relates generally to an online collaborative environment that connects various users with different expertise to form a group and exchange their services based on an invention/idea. The online collaborative electronic environment provides a platform to submit semi-automatic provisional patent applications that are displayed in real-time. The electronic application also facilitates evaluation and funding of inventions/ideas.

B. Background of the Invention

Presently, we are faced with an economic climate that requires agility in order to capitalize on new inventions that are developed. Computers and the interne have changed the method of business transactions in such a way that virtually every individual in this planet can engage in commerce regardless of geographical or geopolitical location. Consequently, the process of delivering products and services has evolved, and companies adopted various strategies to capitalize on these efficient avenues of commerce.

In this millennium, we've seen major developments banking, auctions, information exchange, and communication. Furthermore, there are various businesses in the market that currently utilize the Internet as the sole venue of conducting transactions. These companies have succeeded in various ways, have attracted the attention of many customers, and met the needs of millions of people. In the inventive world, however, there are some glaring needs that have not been fulfilled by the current market.

There are many examples of enterprises that collect information from the inventive communities, such as: business plans, ideas, strategies, and technical knowledge. These companies, however, offer no collaborative platform that enables inventors to connect with other like-minded individuals, legal professionals, investors, and the general public, for 1) legal services, 2) funding, 3) critiques, and 4) evaluation of inventions/ideas. Furthermore, the incentive for public disclosure of ideas is met only through the patent applications system, which on average takes 18 months for the public to see and evaluate an invention/idea.

The present invention, a collaborative electronic environment, aims to meet the needs (vide supra) of the inventive community. Disclosure of inventions will be encouraged through the real-time preparation of the provisional patent applications by a semi-automatic electronic preparation application. This approach will give inventors the security that comes with the “patent pending” model, and will serve as the seed to for evaluation, collaboration, investment, and product/service development.

### SUMMARY OF THE INVENTION

The present invention offers independent inventors an interactive electronic platform that enables them to prepare a provisional patent application. This interactive electronic platform provides the user with step-by-step instructions on how to prepare the application, and automatically completes the forms that are required to file the application by a program that gathers data from the user. The inventor is provided with options after the completion of the patent application. Option one, the inventor can complete the application package by submitting information in the program, and mail the application directly to the United States Patent and Trademark Office (USPTO). Option two, the inventor can retrieve data from the network, and choose from a collection of information a legal entity to evaluate the patent application and submit the information either electronically or manually. Option three, the inventor can complete the application and then direct the program to send the application electronically to the USPTO.

Inventions are automatically organized in the network, in real-time, with the most recent invention appearing on-top of the tabulated data. The inventions contain, a title, a name, an invention/idea number, a drawing, an abstract, a video, and an email of the inventor. Once information is entered, the patent application service application checks to ensure that it is complete before creating a permanent non-changeable record, generating a printable report that contains all the necessary information for the submission of patent application, including instructions, and transmits the application electronically to the USPTO.

Users are limited in their functions and the network identifies them as inventors, investors, legal professionals, and the public. Inventors can create invention/idea records that contain all the necessary information to accord a patent application a filling date, in addition, video is accepted and supported by the service application. Investors can review invention records, support inventions financially, and establish electronic connections with users of the network. Legal professionals (patent attorneys and patent agents) can access provisional patent application files, provided the inventor contracts them. The patent application file is exchanged electronically between the inventor and the legal professional, who upon receiving payment for the services has access to the service application for the preparation of the provisional patent application, which the service application uses to create the invention record.

The service application consists of different consoles that are automatically created based on the function of the user. The inventor console contains the most elements, including access to the automatic and semi-automatic application for the creation of patent applications. Information is collected in various stages, during the creation of a user account for the website, and during the three stage process of creating a provisional patent application. Additional elements of the application consoles include searching for patent attorneys and patent agents, searching for investors, and establishing electronic connections with various users in the network. In general the network supports three types of users, however, conceivably, non-investing users, i.e. the general public, can play the role of an investor.

The network supports seven different types of investors, but additional investor profiles can be supported. The different investors supported by the system are: individual investors (including friends), angel investors, sweat equity investors, venture capital investors, investment bank investors, hedge fund investors, and corporate investors. Their role is captured by the application system during the collection of user information that is necessary to login to the website.

The network accepts documents, comments, investments, and they are organized and tabulated by the system. Popular inventions that receive the most public support are transported to the frontend of the network. Within this pool of inventions emerges one that gathers the most support and all financial resources from the system are directed to that invention. Periodically the system performs this computation and undergoes the necessary steps to accomplish this task.

Inventors have access to information about legal professionals, and investors. Name, email, telephone number, geographical location, education, expertise, and years of experience are organized in electronic business cards in a searchable database. Users within the network can receive real-time messages on inventions entering the system. Computer, phone, Internet, intranet, and any additional electronic device delivers this information. The application system detects the classification of the invention; sorts the invention records for a specific class and upon request tabulates the data for the user.

Inventors, investors, legal professionals, and the public can communicate in real-time through the network, by email, and messaging. Various interactive screens support information transfer between the various users. In addition, the network collects information to enable electronic financial transactions between users, specifically, the inventor and the legal professional. The network through the exchange of information collects financial charges. Name, address, telephone number, email, credit or debit card information, and additional numerical data are collected to insure financial transactions. The data is transmitted electronically from one party to the next, and is stored and organized in the network. In addition, users can rate one another, the scale of which is not limited. This information is organized, and tabulated by the network.

Users can donate/submit money by credit, debit, or any additional electronic payment to support an invention. The total amount of money donated for a particular invention appears within the location of the invention information in the network. The total amount changes, and is updated by the network in real-time. This financial information is used to rate inventions, and determine which of the total that entered the system within a certain period are best supported.

### BRIEF DESCRIPTION OF THE DRAWINGS

FIG. 1 is a diagram of the network including a described embodiment of the present invention and the various components.

FIG. 2 is a diagram of the present invention that includes the various layers of the network, including the databases and the application.

FIG. 3 is a diagram of the application preparation system that includes the dynamics of the software application and the generation of application records.

FIG. 4 is a diagram of the database and the system of interacting with intellectual property professionals.

FIG. 5 is a diagram of the various components of the application package of record generation and the distribution of information created by the software application.

FIG. 6 is a diagram of the financial transaction between the intellectual property professionals and the inventor.

FIG. 7 is a diagram of the information collected by the network for the intellectual property professionals.

FIG. 8 is a diagram depicting the dynamics of the application preparation system as it pertains to information input and exchange.

FIG. 9 is a diagram depicting the electronic invention financial donation/investment system.

FIG. 10 is a screen shot of the inventor interface of the network, which includes the various components needed to create the patent application.

FIG. 11 is a screen shot of the intellectual property professional network interface, which includes the gallery of inventions that depict invention creation in real-time, and the interactive application console.

FIG. 12 is a screen shot of the investor interface, which includes inventions funded and methods of contacting investors in real-time.

FIG. 13 is the first screen shot of the “Apply for Patent” console, which is part of the application preparation system, including the guidance boxes, and information input.

FIG. 14 is the second screen shot of the “Apply for Patent” console, which is part of the application preparation system, including the guidance boxes, and information input.

FIG. 15 is the third screen shot of the “Apply for Patent” console, which is part of the application preparation system, including the guidance boxes, information input, and inventor information collection for the automatic generation of the application package.

FIG. 16 is the fourth screen shot of the “Apply for Patent” console, which is part of the application preparation system, including the guidance boxes, information input, and the invite friends section of the system.

FIG. 17 is a screen shot of the database of patent attorneys and patent agents, including specific information, and the real-time dynamic mechanism of exchanging information between the inventor and the attorney/agent.

FIG. 18 is a screen shot of the billing section of the application, including method of payment and information section.

FIG. 19 is a screen shot of the database of investors, including methods of connecting with investors, and detailed information of the investor.

### DETAILED DESCRIPTION OF THE PREFERRED EMBODIMENTS

The present invention is an application as a service website that is capable of electronically linking four types of users; inventors, intellectual property professionals, investors, and the general public. This virtual environment through its application software is capable of creating provisional patent applications with user input. The application preparation system guides the user through the preparation of a provisional patent application, and it prepares the necessary forms automatically, including the electronic submission of this information to the respective regulatory entity, in the present embodiment, the United States Patent and Trademark Office (USPTO). The generation of inventions/ideas are collected and stored in real-time, and they are displayed in a section titled gallery of inventions, although not specifically limited by the name. Patent attorneys and patent agents can be contacted for their services through the network, and they have access to the application preparation system, provided the inventor approves them. The network also supports invention and user critiques and/or reviews, and the submission of information, for example prior art documents. Each invention record created supports the submission of drawings and videos.

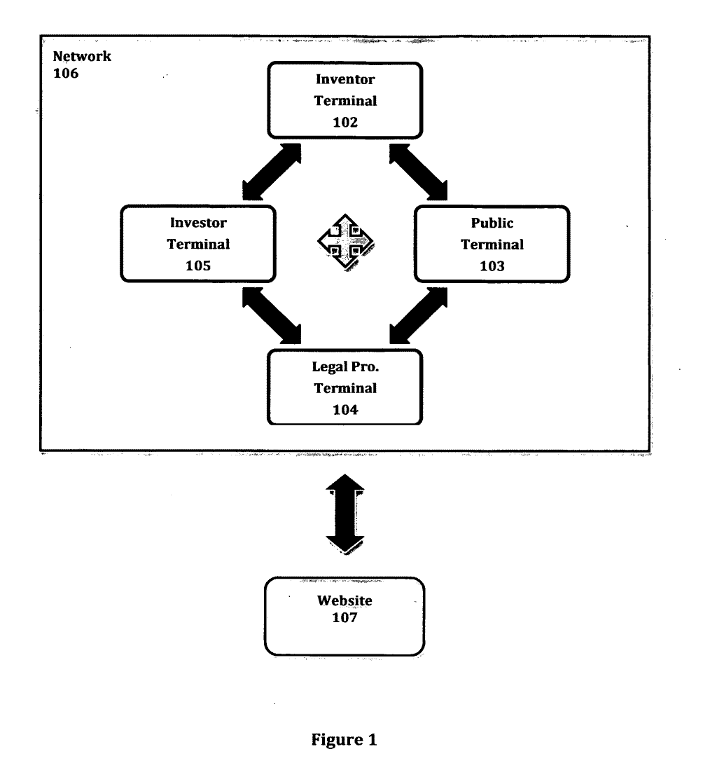

FIG. 1 is an embodiment of the invention that specifically depicts the interactions between the various users. For example, the present invention contains an inventor terminal 102 that enables the inventor to submit information that is necessary for the creation of a provisional patent application. In addition, the inventor can submit videos of their invention, review inventions on the gallery of inventions, critique attorneys and agents that reviewed their patent applications, and contact investors. The public terminal 103, supports public user participation and input. The legal professional terminal 104, enables patent attorneys and patent agents to interact with inventors, review patent applications, submit comments, and viewing of all inventions/ideas through the gallery of inventions. The investor terminal 105, enables investors to view inventions in the gallery of inventions, invest, and at the approval of the inventor, a view of the full application file. This embodiment uses the world-wide-web, however, other protocols maybe used to implement the present invention, such as intranet.

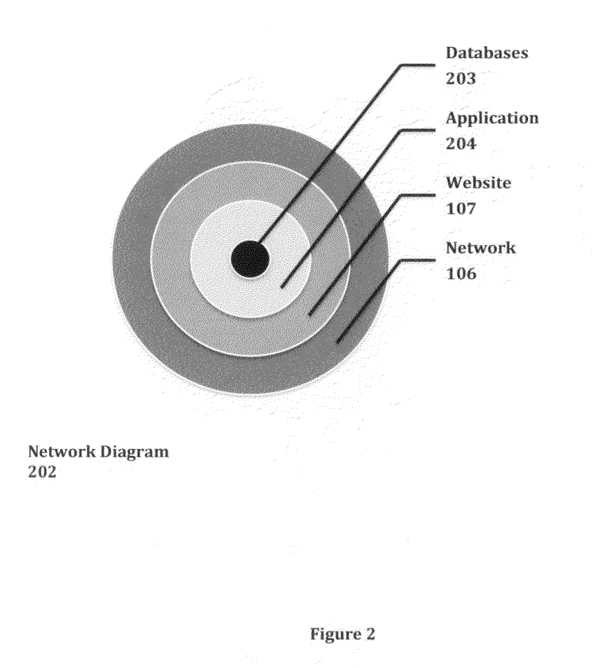

FIG. 2 is an embodiment of the invention that specifically depicts the various components of the network. The network, also named the website, contains databases 203 that collect and organize information pertaining to its users, including information necessary to prepare provisional patent applications, and to enable financial transactions between them. The application 204 prepares the necessary information for the automatic generation of an application file, which is organized in two network folders, the gallery of inventions, and the my inventions section. The website 107 houses the application and the database and further contains information that is pertinent to innovation and patent law. The network 106 encapsulates all the described components that perform the various operations through the software application.

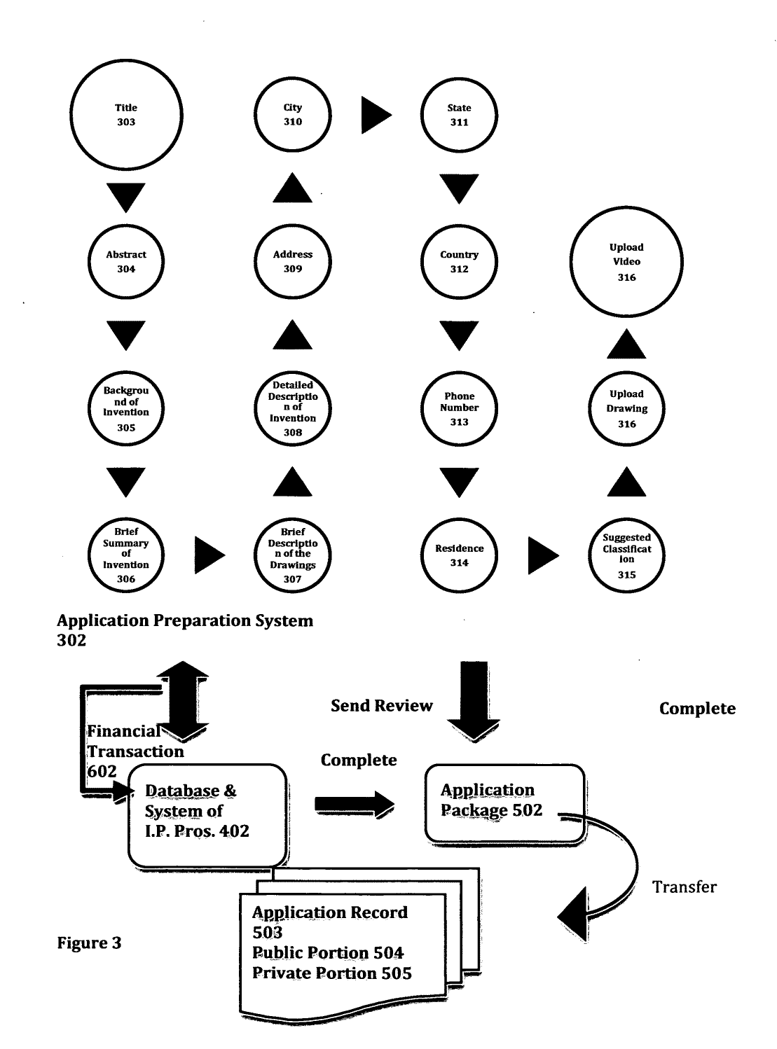

FIG. 3 is an embodiment of the present invention that specifically depicts the various data elements of the application preparation system and the dynamics between the inventor and the legal professional (patent attorney or patent agent). The application preparation system (APS) 302 collects information that is necessary for the automatic creation of provisional patent applications. The following information is collected through this interface, title 303, abstract 304, background of the invention 305, brief summary of the invention 306, brief description of the drawings 307, detailed description of the invention 308, address 309, city 310, state 311, country 312, phone number 313, residence 314, suggested classification 315, drawing 316, and video 317. From the user input, a printable application file is created. The application preparation system also enables the inventor to contact the attorney to send the application for review through the network by selecting an IP professional through the database 402. The network collects financial transactions 602 between those services that are contracted through the website and directs them to an account. The application package 502 once complete is transferred to the gallery of inventions and my inventions in real-time, and is not modifiable by the user, except for the video input 316. The application record 503 is partitioned into two distinct, but related portions, the public portion 504 and the private portion 505.

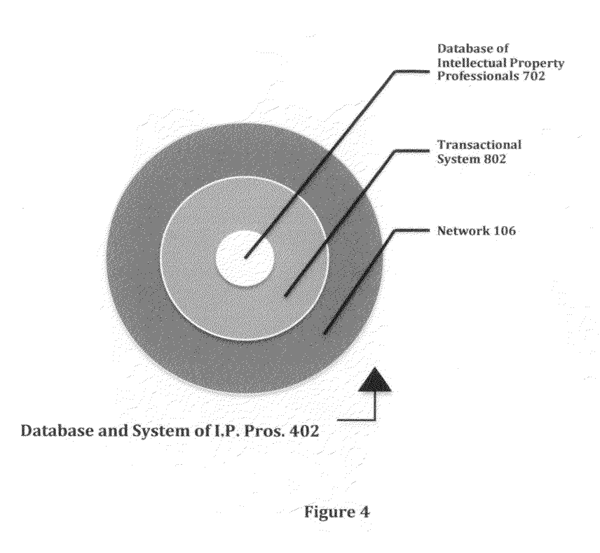

FIG. 4 is an embodiment of the present invention that specifically depicts the various elements of the database and system of intellectual property professionals 402. The database of intellectual property professionals 702 contains information that is collected through the network and it is organized in one section per record. The transactional system 802 enables the connection in real-time or otherwise of attorneys/agents with inventors. The users can exchange information; specifically the provisional application file can be transferred from the attorney/agent to the inventor and vise-versa.

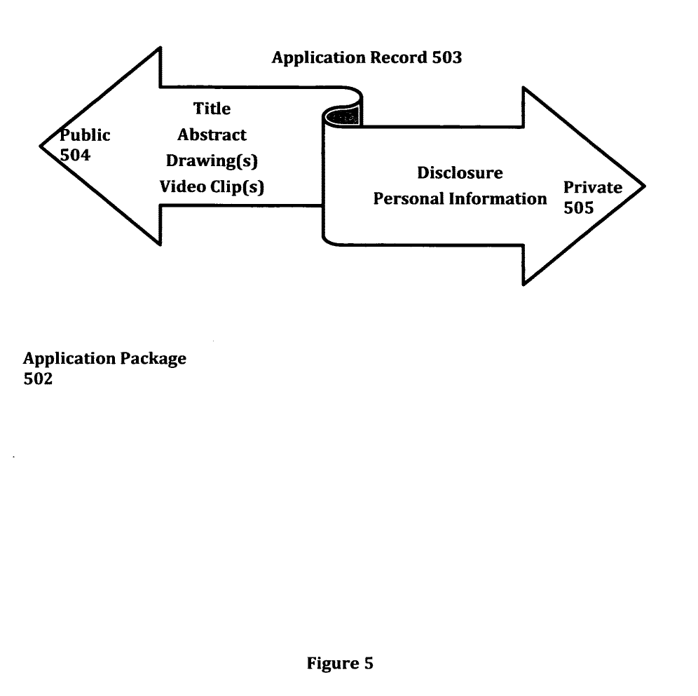

FIG. 5 is an embodiment of the present invention that specifically depicts the application record 503, and the record distribution. The application package 502, is divided into two sections, one for general public viewing 504, and the other for personal record keeping 505, and interactions between the inventor and the legal professional. The public record is tabulated by the application into the gallery of inventions, and specifically includes a title, an abstract, drawings, and video clips. The personal information (my inventions) includes all the information that the public record contains, but in addition also contains the full application file, including the specification and the forms required for submission to the respective regulatory entity.

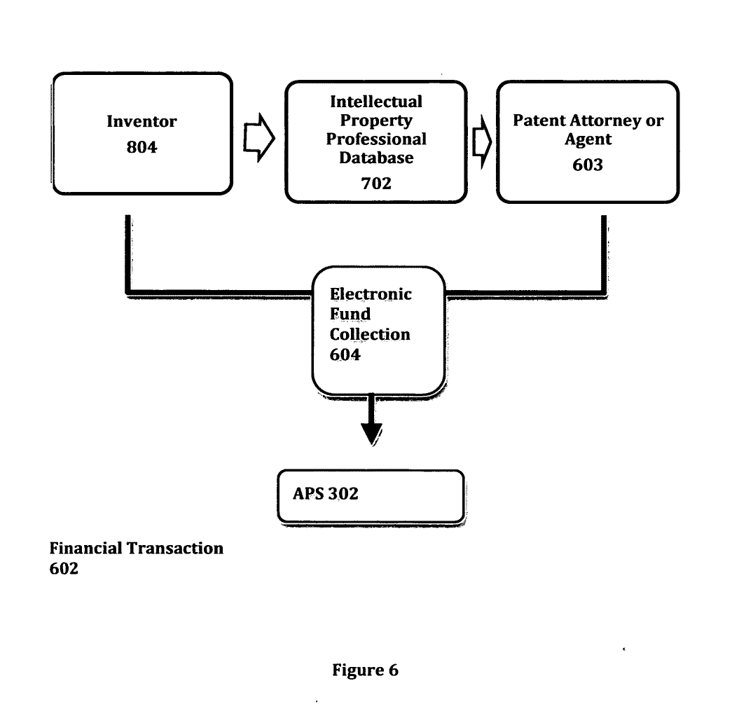

FIG. 6 is an embodiment of the present invention that specifically depicts the various elements of the financial transaction 602 between the inventor, attorney/agent, and the software application. The inventor 804 can contact an attorney/agent 603 for legal services, the database 702 contains information and the software application enables the dynamic exchange of information between the two users. Funds are collected and transferred electronically, and the attorney/agent gains full access to the APS 302. This process yields a new application record collected in the network and a provisional patent application.

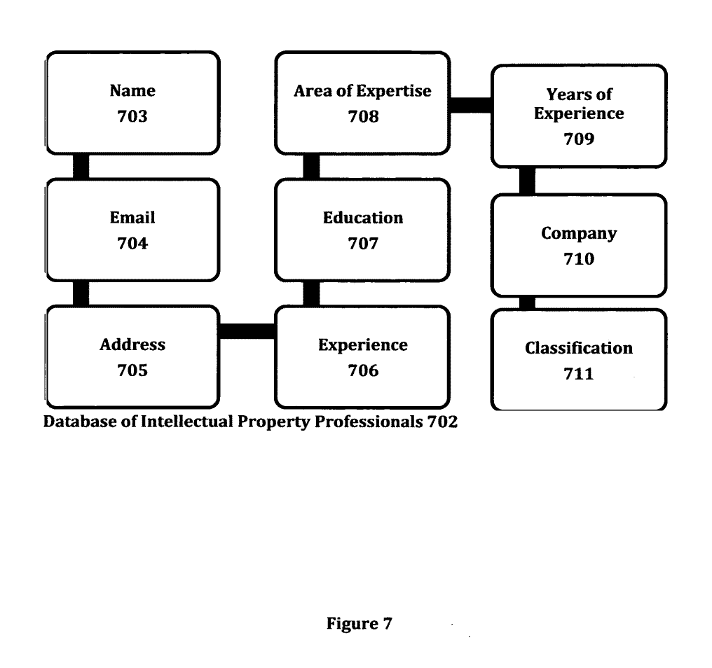

FIG. 7 is an embodiment of the present invention that specifically depicts the various pieces of information that are collected by the software application for the database of intellectual property professionals 702. The name 703, email 704, address 705, experience 706, education 707, area of expertise 708, years of experience 709, company 710, and classification 711 of invention practice are collected and stored in the website. These data are used to automatically prepare the patent application file, and the respective fields are completed by the application system.

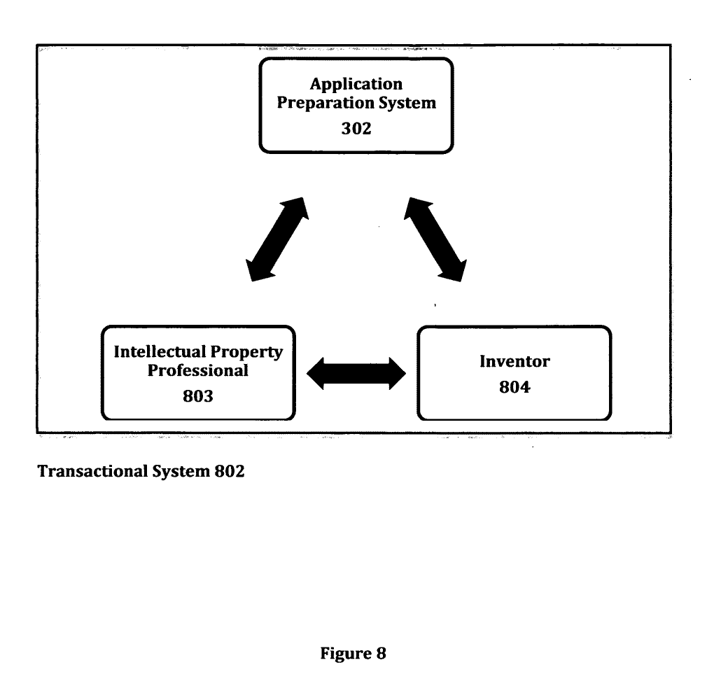

FIG. 8 is an embodiment of the present invention that specifically depicts the various elements of the transactional system 802. The APS 302 through the interactions with the inventor 804 and the intellectual property professionals 803 generates provisional patent applications for submission to the USPTO. Upon accepting a contract from the inventor, the patent attorney or patent agent gains access to the application file, which can be exchanged between the two users within the network. This financial transaction initiates the dynamic patent application review process that facilitates the input of both users towards the application record.

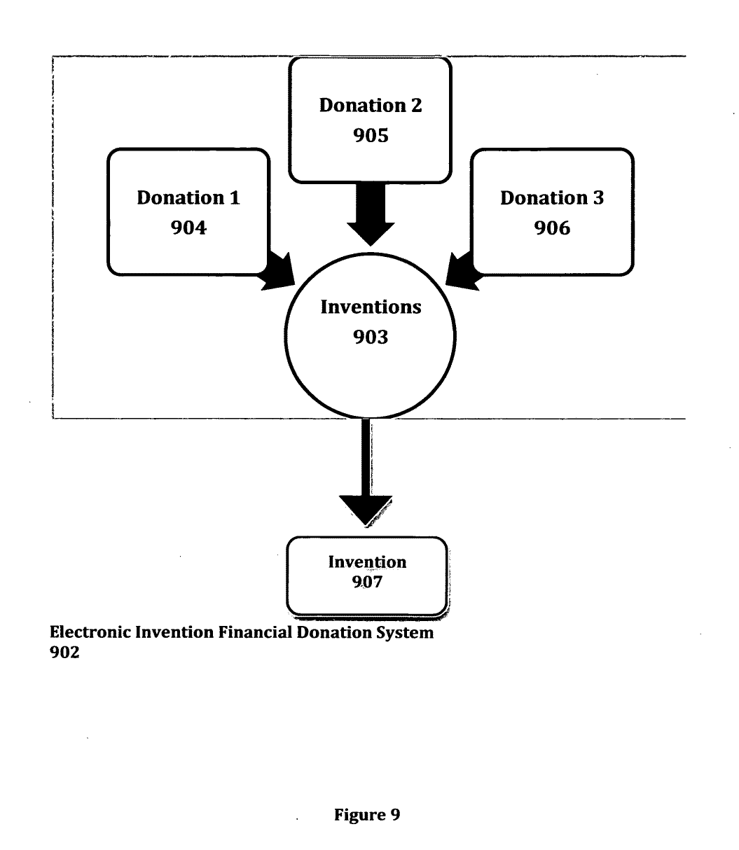

FIG. 9 is an embodiment of the present invention that specifically depicts the system of finance; more specifically termed the electronic invention financial donation system (EIFDS) 902. The network collects money through donations/investment from various sources to a specific invention. Donation 1 904 represents the monetary donation of one source for a given invention 903, and donations 2-3 905-6 from additional sources for the same invention. The application collects the donations and stores them in an account for distribution to the inventor upon reaching a threshold. These financial resources are stored in a network escrow account, and the application system allocates them according to pre-determined out-put conditions that are set by the system administrator.

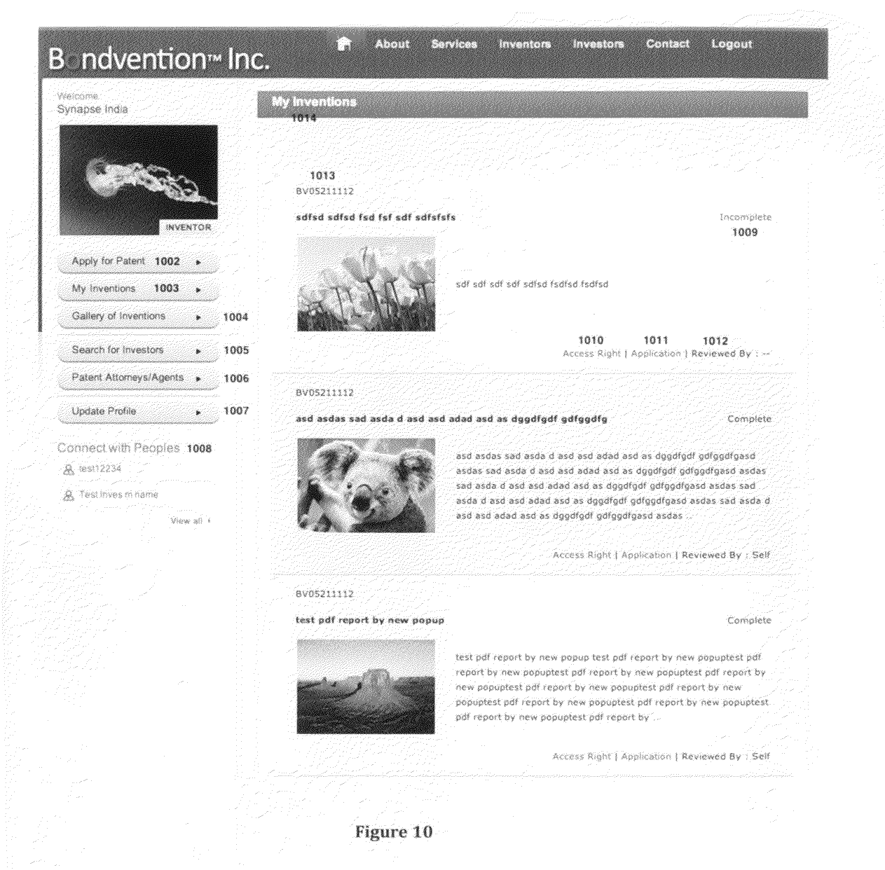

FIG. 10 is an embodiment of the present invention that specifically depicts a screen shot of the inventor console. The inventor console contains various elements that are capable of generating and storing a provisional patent application, and also enable interaction, communication, and depiction of information. The apply for patent 1002 console button signals the application software to initiate the platform for the semi-automatic creation of the patent application. The my inventions 1003 console button signals the software to change the viewing of inventions by the inventor in the network. The gallery of inventions console button 1004 signals the software to change the viewing to all inventions created by users. The search for investors 1005 console button triggers the viewing of a database of investors. The patent attorney/agents console button triggers the viewing of information contained in a database within the website. Update profile 1007 provides a platform to modify or update user information. The connect with peoples 1008 function enables users to add connections with other users. My inventions 1014 is the database within the network that only contains inventions created by the specific user, that include an application record number 1013, an indicator of progress 1009, a list of the users that have full access to the invention record 1010, the full application record link 1011, and the record of review 1012 of the application. Inventions are tabulated by the application software in the manner depicted in FIG. 10, but can be modified by the system administrator.

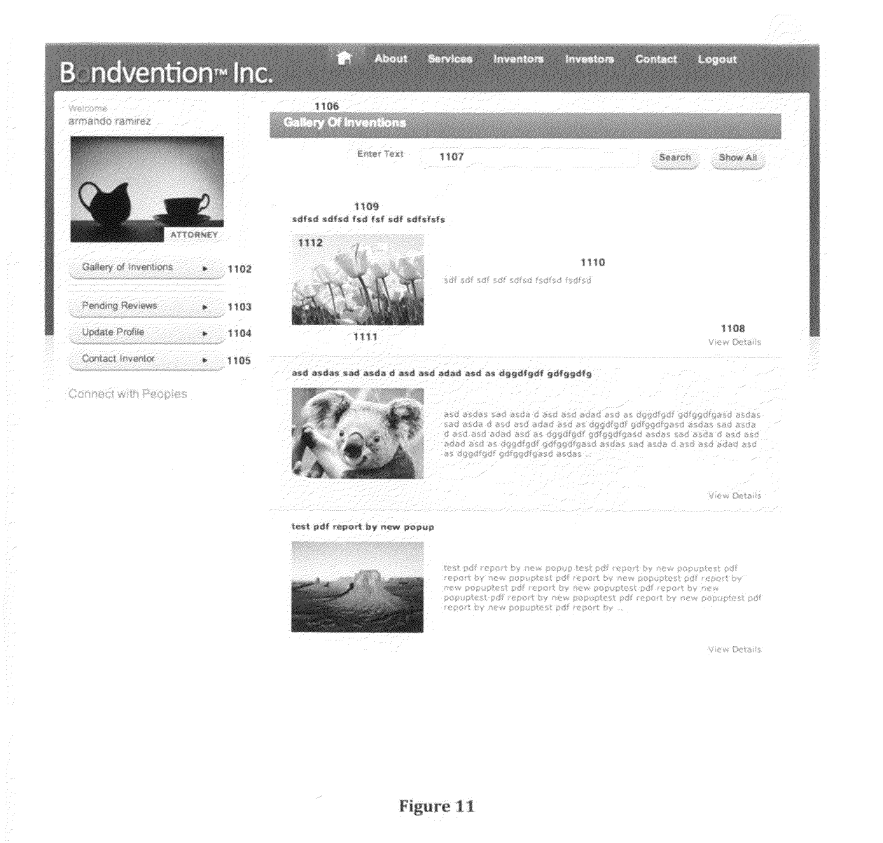

FIG. 11 is an embodiment of the present invention that specifically depicts a screen shot of the patent attorney and patent agent console. The patent attorney and patent agent console contains various elements that are capable of generating and storing a provisional patent application, and also enable interaction, communication, and depiction of information. The gallery of inventions 1102 console button signals the software application to display the full public database of inventions that are tabulated in real-time. The pending reviews 1103 console button signals the system to display a record of those inventions that patent attorneys and patent agents are reviewing for inventors. The update profile 1104 console button provides a platform where users can update and modify their information. The gallery of inventions 1106 contains a collection of tabulated records for each invention that are updated in real-time. The collection of records includes, title of the invention 1109, drawings 1112, abstract of the invention 1110, a link for video 1111, and a link to view the details 1108 of the invention. Data/information can be searched by entering the desired parameters in the enter text box 1107.

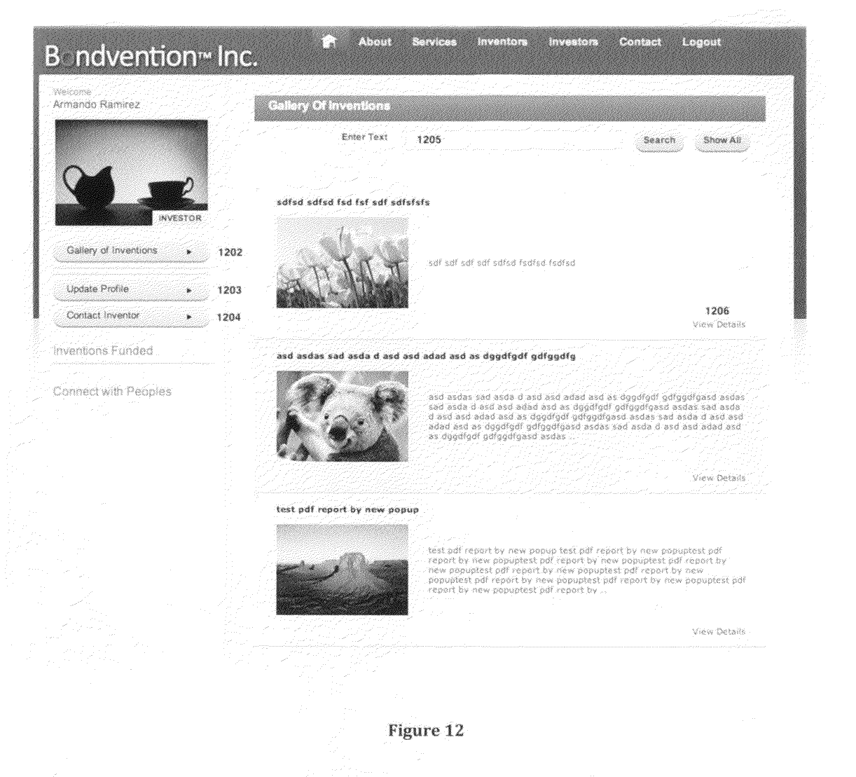

FIG. 12 is an embodiment of the present invention that specifically depicts a screen shot of the investor console. The investor console contains various elements that enable interaction, communication, and depiction of information. The gallery of inventions 1202 console button signals the software application to display the full database of inventions that are tabulated in real-time. Update profile 1203 console button provides a platform where investors can update and modify their information. The contact inventor console button 1204 provides a platform for the investor to contact the inventor and tabulates those connections under connect with peoples. The investor console also keeps records of inventions that are funded by the specific investor.

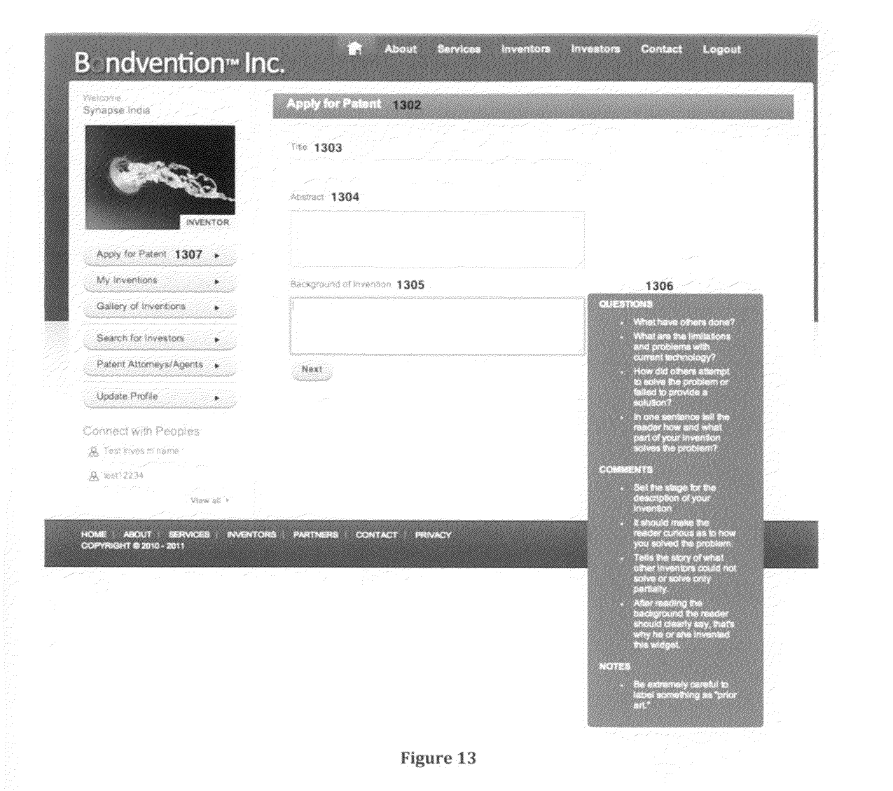

FIG. 13 is an embodiment of the present invention that specifically depicts a screen shot of the apply for patent 1302 application software. The apply for patent 1307 console button signals the software to activate the semi-automated provisional patent application software that collects from the user a title 1303 of the invention, an abstract 1304 of the invention/idea, and a background of the invention 1305. The application software generates guidance boxes 1306 upon activating the specific user input box and contains information that is relevant to the topic at issue.

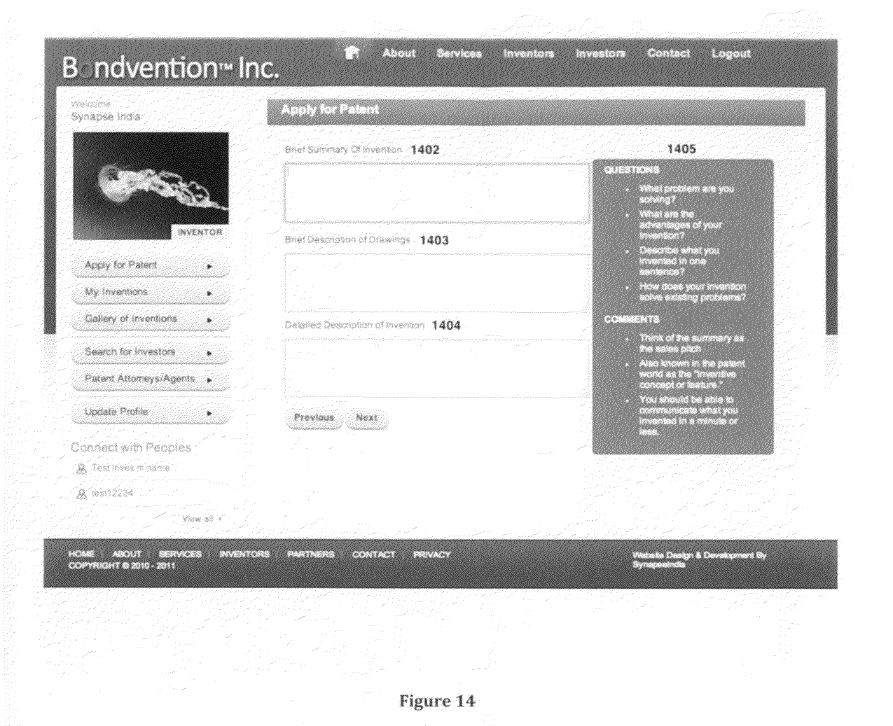

FIG. 14 is an embodiment of the present invention that specifically depicts a screen shot of the apply for patent application software. The apply for patent 1307 console button signals the software to activate the semi-automated provisional application software that further collects from the user a brief summary of the invention 1402, a brief description of the drawings 1403, and a detailed description of the invention 1404. The application software generates guidance boxes 1405 upon activating the specific user input box and contains information that is relevant to the topic at issue.

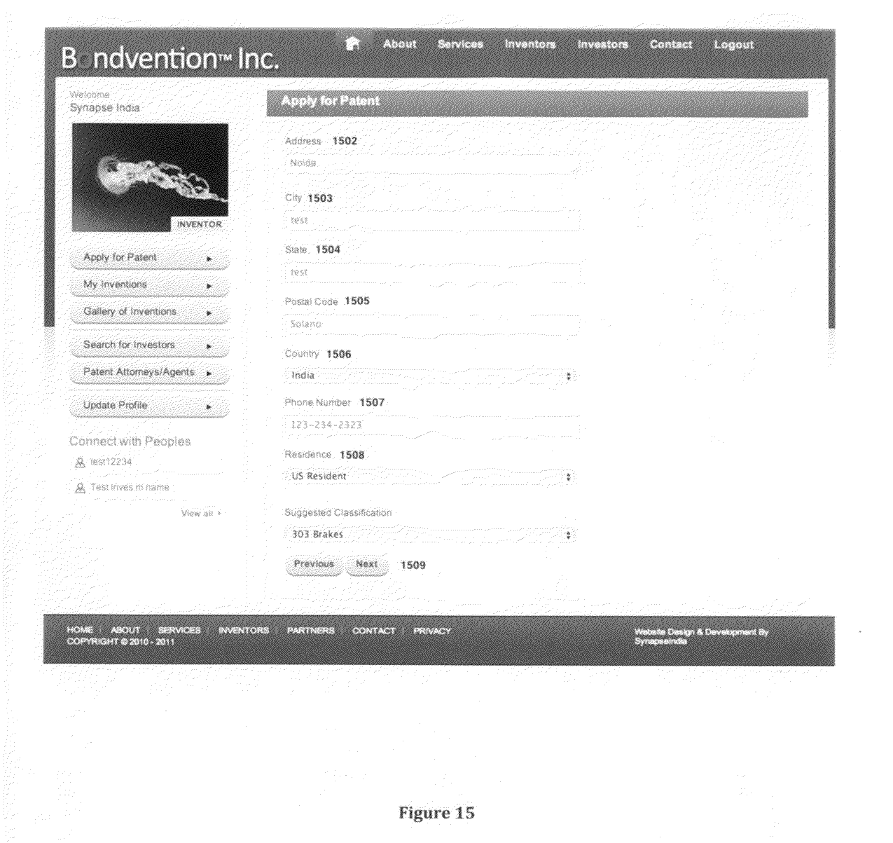

FIG. 15 is an embodiment of the present invention that specifically depicts a screen shot of the apply-for-patent application software. The apply-for-patent 1307 console button signals the software to activate the semi-automated provisional application software that further collects from the user their address 1502, city 1503, state 1504, postal code 1505, country 1506, phone number 1507, residence 1508, and suggested classification 1509.

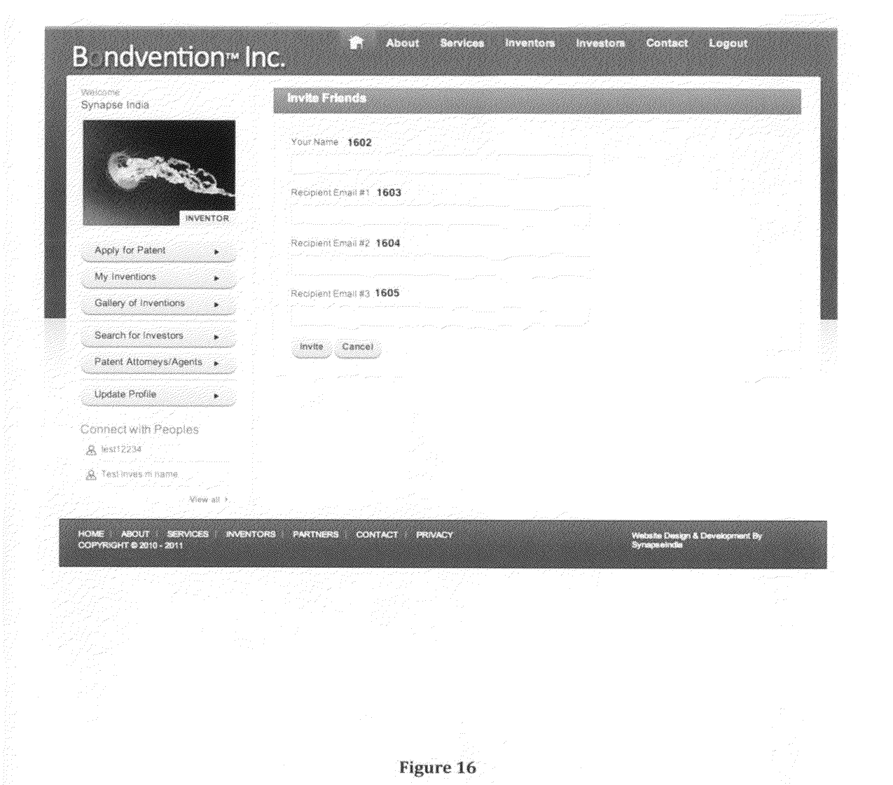

FIG. 16 is an embodiment of the present invention that specifically depicts a screen shot of the apply-for-patent application software. The apply-for-patent 1307 console button signals the software to activate the semi-automated provisional application software that further enables the user to invite friends by entering their name 1602, and the email addresses of the recipients 1603-1605.

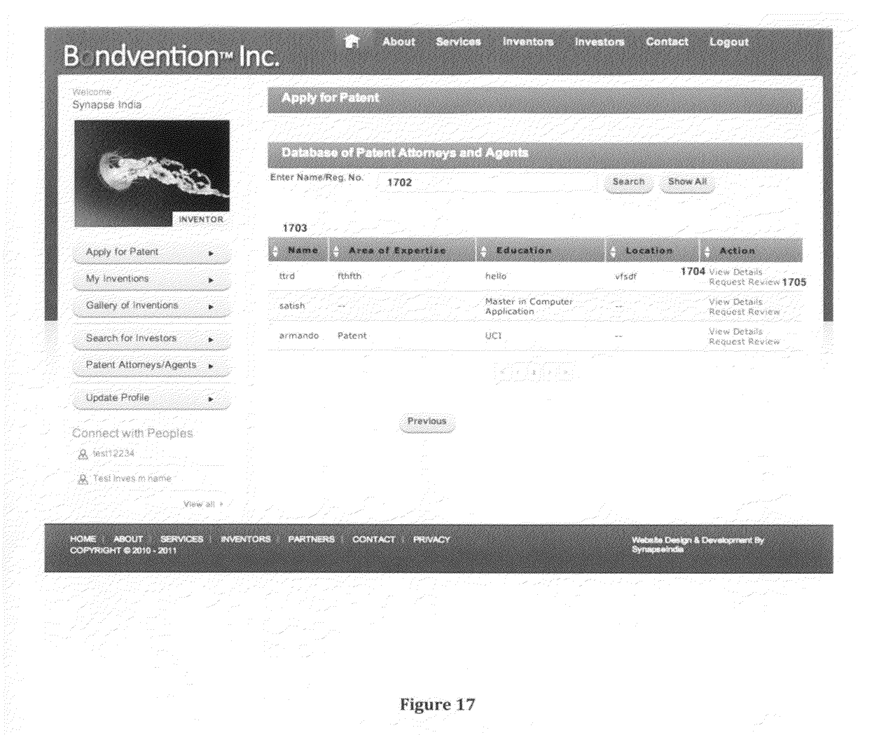

FIG. 17 is an embodiment of the present invention that specifically depicts a screen shot of the database of patent attorneys and agents 1703 that is accessible to users through the patent attorney and patent agent console button. The database is searchable by name or registration number 1702, including additional search parameters. The database includes a link to view the details 1704 of for each record, and a button to request provisional patent application review 1705 from the patent attorneys and patent agents.

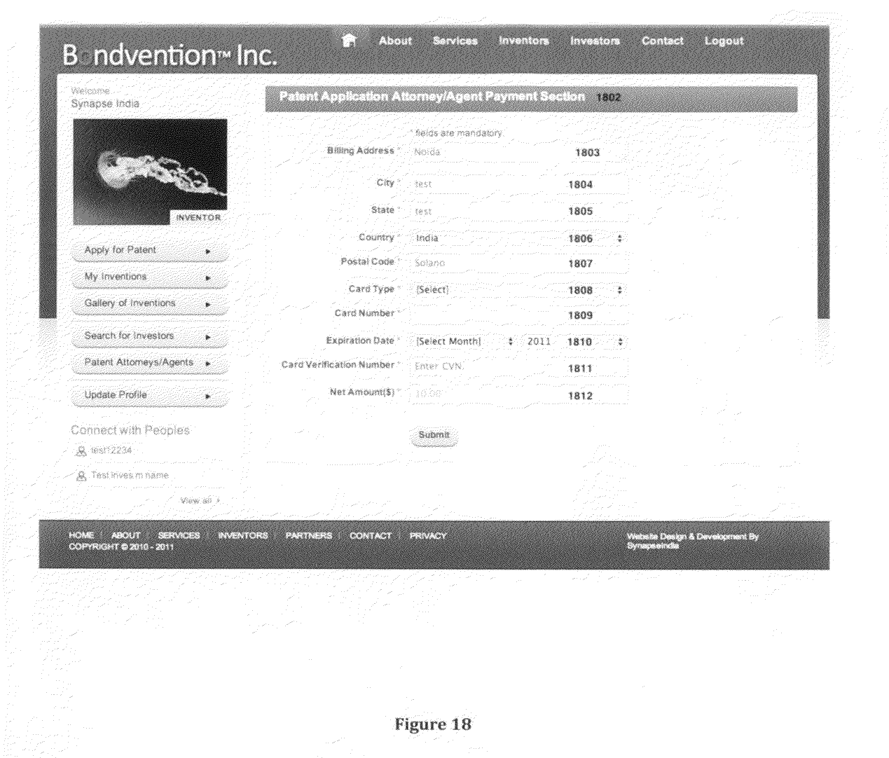

FIG. 18 is an embodiment of the present invention that specifically depicts a screen shot of the billing section of the application. This section of the network collects the billing address 1803 of the user, the city 1804, state 1805, country 1806, postal code 1807, card type 1808, card number 1809, expiration date 1810, card verification number 1811, and net amount 1812.

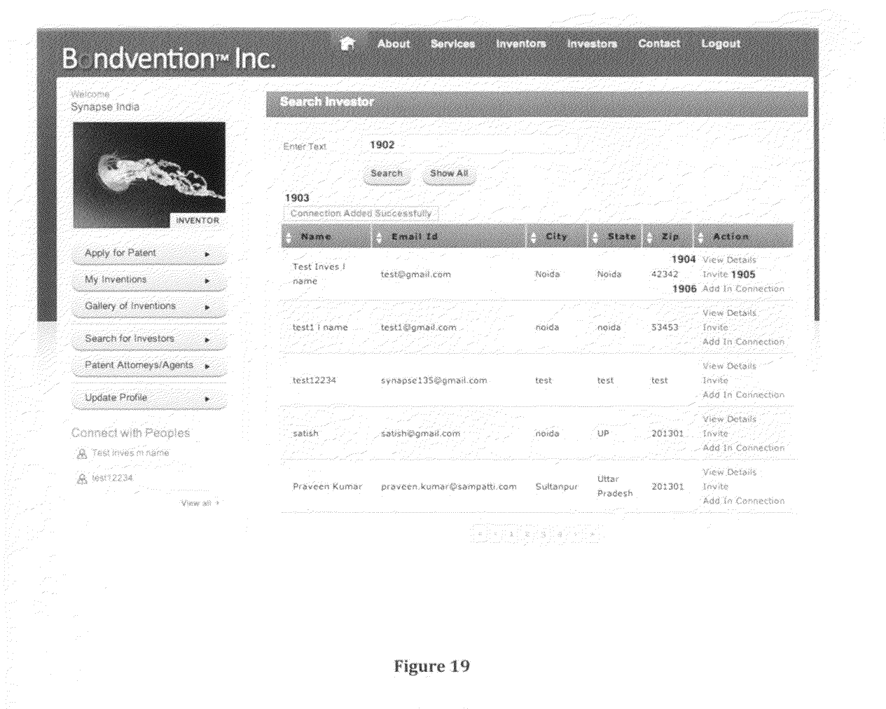

FIG. 19 is an embodiment of the present invention that specifically depicts a screen shot of the investor database 1903. The database is searchable by text 1902, and contains details 1904 of each investor. The invite 1905 button of the database of investors provides a platform to enable investors to connect with inventors. Add in connection 1906 button electronically links the two users and the application software updates the connect with peoples section of the console.

This computer implemented method also accepts a posting on a website of a patent application record that an inventor wants reviewed, and the database contains registered patent attorneys and patent agents. They receive a proposal on the contract from any inventor, where all registered contractors are qualified to bid on the reviewing process, which allows the attorney or agent to accept the provisional patent application review bid from the inventor. This process allows the buyer and the seller to work on the project in a collaborative electronic environment accessible by only the inventor and the patent attorney and patent agent, where the patent attorney or patent agent develops and delivers the project in the electronic environment upon its completion.

The invention claimed is:

1. An electronic implemented method, comprising:
an application preparation system, a database of inventions, a database of inventors, a database of attorneys, a database of agents, and a database of investors;
said application preparation system collects information that is necessary for the creation of intellectual property applications.

2. The electronic implemented method of claim 1, wherein the database of inventions is updated and displayed in real-time.

3. The electronic implemented method of claim 2, wherein the real-time update of inventions is independent of physical location.

4. The electronic implemented method of claim 1, wherein the application preparation system creates provisional patent applications automatically.

5. The electronic implemented method of claim 1, wherein the application preparation system creates provisional patent applications semi-automatically.

6. The electronic implemented method of claim 5, wherein the semi-automatic creation is by user input and computation.

7. The electronic implemented method of claim 6, wherein the said user is an inventor, a patent attorney, or a patent agent.

8. The electronic implemented method of claim 1, wherein the said database of inventions supports video input and display.

9. The electronic implemented method of claim 8, wherein the said video relates to the invention record.

10. The electronic implemented method of claim 1, wherein the said method accepts invention investment.

11. The electronic implemented method of claim 10, wherein the said investment is money.

12. The electronic implemented method of claim 10, wherein the said investment if a donation.

13. The electronic implemented method of claim 1, wherein said electronic method is selected from the group consisting of a computer, a portable electronic device, a mobile phone, a smart phone, and a laptop.

14. The electronic implemented method of claim 1, wherein the said intellectual property application is a provisional patent application.

15. The electronic implemented method of claim 1, wherein the said attorney is a patent attorney.

16. The electronic implemented method of claim 1, wherein the said agent is a patent agent.

17. The electronic implemented method of claim 1, wherein the said application preparation system generates a printable application package.

18. An computer implemented method, comprising:
an application preparation system, a database of inventions, a database of inventors, a database of attorneys, a database of agents, and a database of investors;
the application preparation system collects information that is necessary for the creation of intellectual property applications;
and collects investments.

19. The computer implemented method of claim 18, wherein the database of inventions is updated in real-time.

20. The computer implemented method of claim 19, wherein the real-time update of inventions is independent of physical location.
